(19) United States
(12) Patent Application Publication
(10) Pub. No.: US 2026/0179907 A1
(43) Pub. Date: Jun. 25, 2026

(54) DRY-TYPE METHOD FOR MANUFACTURING SECONDARY BATTERY ELECTRODE, SECONDARY BATTERY ELECTRODE MANUFACTURED USING THE SAME METHOD, AND SECONDARY BATTERY INCLUDING THE SAME ELECTRODE

(71) Applicant: KNU-Industry Cooperation Foundation, Chuncheon-si (KR)

(72) Inventors: Sung Hun CHOI, Gwangju (KR); Ji Seong KIM, Incheon (KR); Jong Seok PARK, Chuncheon-si (KR)

(21) Appl. No.: 19/430,296

(22) Filed: Dec. 23, 2025

(30) Foreign Application Priority Data
Dec. 23, 2024 (KR) 10-2024-0193606
Feb. 14, 2025 (KR) 10-2025-0019202

(51) Int. Cl. H01M 4/04; H01M 4/62; H01M 4/02; H01M 4/587

(52) U.S. Cl. CPC H01M 4/0471; H01M 4/043; H01M 4/622; H01M 2004/027; H01M 4/587

(57) ABSTRACT

The present invention relates to a method for manufacturing a dry secondary battery electrode, a secondary battery electrode manufactured by the method, and a secondary battery including the same, and, specifically, relates to a method for manufacturing a dry secondary battery electrode in which a low-temperature process is possible and formation of an open-channel interface is possible, thereby having excellent electrochemical characteristics, a secondary battery electrode manufactured by the method, and a secondary battery including the same.

### TECHNICAL FIELD

The present invention relates to a method for manufacturing a dry secondary battery electrode, a secondary battery electrode manufactured by the method, and a secondary battery including the same, and, specifically, relates to a method for manufacturing a dry secondary battery electrode in which a low-temperature process is possible and formation of an open-channel interface is possible, thereby having excellent electrochemical characteristics, a secondary battery electrode manufactured by the method, and a secondary battery including the same.

### BACKGROUND ART

Due to the rapid increase in the use of fossil fuels, demands for the use of alternative energy and clean energy are increasing, and, as a part thereof, the field being most actively researched is power generation and power storage using electrochemistry.

As a representative example of an electrochemical device currently using electrochemical energy, a secondary battery may be mentioned, and the use area thereof is tending to be expanded more and more.

A lithium secondary battery, which is one of secondary batteries, is being realized in use not only as an energy source for mobile devices but also, recently, as a power source for electric vehicles and hybrid electric vehicles capable of replacing vehicles using fossil fuels, such as gasoline vehicles and diesel vehicles, which are one of the main causes of air pollution, and the use area is also being expanded for purposes such as an auxiliary power source through grid formation.

The manufacturing process of a lithium secondary battery is largely divided into three stages of an electrode manufacturing process, an assembling process, and a formation process. The electrode manufacturing process is again divided into an active material mixing process, an electrode coating process, a drying process, a rolling process, a slitting process, a winding process, and the like.

Among these, the active material mixing process is a process of blending coating materials for forming an electrode active material layer in which an actual electrochemical reaction occurs in an electrode, and, in detail, is to manufacture, in the form of a slurry having fluidity, by mixing an electrode active material which is an essential element of an electrode and other additives such as a conductive material and a filler, a binder for binding between powders and adhesion to a current collector, and a solvent for imparting viscosity and dispersing the powders.

As described above, the composition mixed for forming an electrode active material layer is also referred to as an electrode mixture in a broad sense.

Thereafter, an electrode coating process of applying the electrode mixture onto a current collector having electrical conductivity, and a drying process for removing a solvent contained in the electrode mixture are performed, and, additionally, the electrode is rolled to be manufactured to a predetermined thickness.

Meanwhile, in the drying process, as the solvent contained in the electrode mixture evaporates, defects such as pinholes or cracks may be caused in the previously formed electrode active layer. In addition, since the inside and the outside of the active layer are not dried uniformly, a powder floating phenomenon due to a difference in solvent evaporation rate, that is, as powders in a portion that is dried first rise and form a gap with a portion that is dried relatively later, electrode quality may be degraded.

Therefore, recently, research on manufacturing a dry electrode that does not use a solvent has been actively conducted.

In general, a dry electrode is manufactured by laminating, on a current collector, a free-standing film manufactured in the form of a film and including an active material, a binder, a conductive material, and the like.

In a process of manufacturing a dry electrode, there is a high shear mixing (High Shear Mixing) process such as jet-milling (Jet-milling) for fibrillating a binder, and, at this time, when a high shear mixing process is applied to a brittle active material, a large amount of fine powder having a small powder size is generated, so that mechanical performance or electrochemical characteristics are likely to be deteriorated, and, when high shear mixing is excessive, the generated binder fibers may be cut to reduce flexibility of a free-standing film. In addition, since the dry electrode is mixed without using a solvent, low homogeneity of compositions forming an electrode active material layer may become a problem. Accordingly, technology development for manufacturing a dry electrode capable of solving these problems is continuing.

Meanwhile, in manufacturing a dry electrode, a fibrous fluorine-containing binder is mainly used. Examples of the fibrous fluorine-containing binder include a fibrous fluorine-containing binder such as polytetrafluoroethylene (PTFE). PTFE forms a three-dimensional binder network and forms, on a surface of an active material, an open-channel interface for lithium ion conduction, and thus has an advantage of effectively lowering interfacial activation energy in a thick-film electrode.

However, the fibrous fluorine-containing binder has a low LUMO energy level, and thus has had a problem in that it is continuously decomposed during charge-discharge cycles, thereby degrading cycle characteristics. In addition, there is a problem in that, in order to form an anode mixture including a fibrous fluorine-containing binder into a film, harsh temperature conditions of 180°C or higher are required. In addition, there is a problem in that polyfluorinated compounds (PFAS) such as PTFE cause environmental problems.

Accordingly, there is a need to develop a process using a binder capable of applying a dry process and, at the same time, not being decomposed during a battery operation process and capable of providing an open-channel interface.

### DISCLOSURE OF THE INVENTION

### TECHNICAL PROBLEM

The present invention has been devised to solve the above-described technical problems, and an object to be solved by the present invention is to provide a method for manufacturing a dry secondary battery electrode having excellent electrochemical stability.

Another object to be solved by the present invention is to provide a method for manufacturing a dry electrode, which can be performed at a low temperature.

Another object to be solved by the present invention is to provide a method for manufacturing a dry secondary battery electrode, which can not only achieve strong adhesion between electrode active materials through a low-temperature process, but also has robust structural stability even at a high loading level after manufacturing.

Other objects, specific advantages, and novel features of the present invention will become more apparent from the following detailed description and preferred embodiments with reference to the accompanying drawings.

### TECHNICAL SOLUTION

In order to solve the above-described technical problems, the present invention provides a method for manufacturing a secondary battery electrode, comprising: 1) mixing an electrode active material and a pressure sensitive adhesive (Pressure Sensitive Adhesive, PSA) in a powder-phase; and 2) pressurizing the mixture of the step 1) to form the mixture into a film shape.

In one embodiment of the present invention, the pressure sensitive adhesive (PSA) may not include fluorine (Fluorine).

In one embodiment of the present invention, the pressure sensitive adhesive (PSA) may be a polymer including an unsaturated C–C double bond.

In one embodiment of the present invention, the step 1) may further include, thereafter, performing a freeze-drying process on the mixture.

In one embodiment of the present invention, the freeze-drying process may include a step of freezing at a rate of 0.5°C/sec to 1°C/sec.

In one embodiment of the present invention, the step 2) may be performed at a temperature of 0°C to 40°C.

In one embodiment of the present invention, the step 2) may be formed by applying a pressure of 0.7 MPa or more.

In one embodiment of the present invention, the secondary battery electrode is an anode, and the electrode active material may be a carbon-based active material.

The present invention provides a secondary battery electrode manufactured by the method for manufacturing a secondary battery electrode.

In one embodiment of the present invention, the pressure sensitive adhesive (PSA) may not include fluorine and may be a polymer including an unsaturated C–C double bond.

The present invention provides a secondary battery including: the secondary battery electrode; a counter electrode; a separator interposed between the secondary battery electrode and the counter electrode; and an electrolyte impregnated in the separator.

### ADVANTAGEOUS EFFECTS

The method for manufacturing a dry secondary battery electrode according to the present invention can significantly reduce process costs compared to a conventional wet secondary battery electrode manufacturing method, thereby improving price competitiveness of a secondary battery.

In addition, even when a thick-film electrode is manufactured with a high loading amount, a secondary battery electrode having excellent electrochemical characteristics can be manufactured, and thus it is expected that capacity and cycle characteristics of a secondary battery can be significantly improved.

In addition, it is possible to provide a method for manufacturing a dry secondary battery electrode using a binder that is electrochemically stable and is not decomposed during operation of a secondary battery.

### BRIEF DESCRIPTION OF THE DRAWINGS

FIG. 1a is a schematic view illustrating a freeze-drying step during the dry electrode manufacturing process of the present invention.

FIG. 1b is a photograph comparing electrodes according to Examples 1, 3, and 4.

FIG. 1c is a photograph comparing appearances when folding is applied to electrodes according to Examples 1, 3, and 4.

FIG. 2a is a schematic diagram of the dry electrode manufacturing process of the present invention.

FIGS. 2b and 2c are scanning electron microscope (SEM) photographs capturing appearances of an anode mixture manufactured in steps of the dry electrode manufacturing process of the present invention.

FIG. 3a is a transmission electron microscope (TEM) photograph capturing a surface of graphite particles included in a graphite anode according to a preferred embodiment of the present invention.

FIG. 3b is a transmission electron microscope (TEM) photograph capturing a surface of graphite particles included in a graphite anode manufactured according to a conventional wet process.

FIG. 4a compares first-cycle voltage-capacity graphs of half-cells according to Preparation Example 1 and Preparation Example 2.

FIG. 4b shows CV (cyclic voltammetry) curves of half-cells according to Preparation Example 1 and Comparative Preparation Example 2.

FIG. 5a is a graph comparing capacity changes according to current density of a full cell of Preparation Example 3 and Comparative Preparation Example 3.

FIG. 5b is a graph showing cycle characteristics of full cells of Preparation Example 3, Comparative Preparation Example 3, and Comparative Preparation Example 4.

### MODE FOR CARRYING OUT THE INVENTION

Hereinafter, principles of a preferred embodiment of the present invention will be described in detail with reference to the accompanying drawings and description. However, the drawings shown below and the description to be described later are directed to a preferred implementation method among various methods for effectively describing features of the present invention, and the present invention is not limited only to the drawings and description below.

In the present specification, expressions in the singular include expressions in the plural, unless the context clearly indicates otherwise.

In the present specification, terms such as “include” or “have” are intended to designate that the described feature, number, step, operation, component, part, or a combination thereof is present, and should be understood as not precluding in advance the presence or addition possibility of one or more other features, numbers, steps, operations, components, parts, or combinations thereof.

Unless defined otherwise, all terms used herein, including technical or scientific terms, have the same meanings as those generally understood by a person having ordinary skill in the art. Terms such as those defined in generally used dictionaries should be interpreted as having meanings consistent with meanings in the context of the related art, and, unless explicitly defined in the present specification, are not interpreted as having ideal or excessively formal meanings.

Hereinafter, a method for manufacturing a dry secondary battery electrode according to the present invention, a secondary battery electrode manufactured by the method, and a configuration of a secondary battery including the electrode will be described in detail.

As described above, a conventional electrode for a lithium secondary battery used a wet process using a solvent in order to form a uniform active material layer. In the wet process, an electrode slurry having fluidity is manufactured by mixing an electrode active material, a conductive material, and a binder with a solvent for dispersion, and the electrode slurry is applied to a current collector and then a remaining solvent is dried to manufacture a final electrode. In the wet process, during the drying process, distribution of compositions constituting an electrode active material layer becomes non-uniform due to solvent evaporation, thereby deteriorating quality of the electrode and causing degradation of performance of a battery.

Meanwhile, in a dry process for solving the problems of the wet process, there has been a problem in that a fibrous fluorine-containing binder, which is mainly used as a dry binder, is spontaneously and irreversibly decomposed in an operating voltage range of a battery, thereby shortening a lifetime of a secondary battery.

Accordingly, the present inventors, in order to solve the above-described problems, 1) a step of mixing an electrode active material and a pressure sensitive adhesive (PSA); and 2) a step of pressurizing the mixture of the step 1) to form the mixture into a film shape; have developed a method for manufacturing a dry secondary battery electrode.

In a preferred embodiment of the present invention, a step of cooling and pulverizing the mixture mixed in the step 1) may be further included. Since a dry process does not use a solvent, when components of an electrode are simply mixed, the components may not be uniformly mixed. Therefore, after mixing the electrode active material and the pressure sensitive adhesive (PSA), a pulverization process is required for uniform mixing.

Specifically, the step of cooling and pulverizing the electrode active material and the pressure sensitive adhesive (PSA) may use a freeze-drying process. The freeze-drying step may be performed after the step 1).

In one embodiment of the present invention, after a mixture obtained by mixing the electrode active material and the pressure sensitive adhesive (PSA) is put into water (preferably distilled water), the mixture may be uniformly mixed by preparing the mixture as a slurry having a solid content of 1% to 70%. If the solid content is less than 1%, a time required for drying is excessively long and stratification may occur during the drying process, so that uniform mixing may become difficult. Conversely, if the solid content exceeds 70%, fluidity of the slurry is lowered, so that uniform mixing may become difficult.

Thereafter, the slurry may undergo a step of rapidly cooling to a temperature of 0°C or lower.

The rapid cooling may be a step of freezing at a rate of 0.5°C/sec to 1°C/sec. Here, through rapid cooling, electrode components (such as the electrode active material and the pressure sensitive adhesive) may be uniformly mixed.

Thereafter, a step of drying the mixture on which rapid cooling has been performed may be performed. The drying step may preferably be performed in a vacuum state. At this time, the drying step may be performed while maintaining a temperature of 0°C or lower. Preferably, the drying step may be performed at a temperature of −10°C to 0°C for 1 hour to 72 hours, or 1 hour to 24 hours, and may be performed for up to one week.

The active material-binder mixture mixed and pulverized through the above steps may be dried as it is in a state of being uniformly dispersed in the slurry, so that a uniform mixture may be obtained.

According to a preferred embodiment of the present invention, the dried mixture may be ground using a mortar or the like to obtain a powder-phase active material-binder mixture, and may be provided to the press molding step of the step 2).

The method for manufacturing a dry secondary battery electrode according to the present invention can omit a separate high-temperature solvent drying process by being manufactured by a powder-to-film process in which a powder-phase active material-binder mixture is press molded (all solvent is removed in the press molding process) without using a solvent to form into a film, and can prevent a problem in which a binder forms a closed-channel interface on a surface of an electrode active material (e.g., a carbon-based active material).

In addition, the present invention does not require a step of fibrillating under high-temperature conditions during press molding by using a pressure sensitive adhesive (PSA) as a binder. A pressure sensitive adhesive (PSA) is also referred to as a pressure sensitive adhesive, and is a type of adhesive in which adhesive force is generated when pressure is applied, and has a feature of not requiring a solvent, heat, light, and the like in order to generate adhesive force. That is, under conditions of room temperature and atmospheric pressure, it shows behavior of an elastic body (provided in a powder-phase), but when high external pressure is applied, it exhibits high adhesiveness even under room temperature conditions, and when the external pressure is removed, it returns to an original state to enable a firm bonding.

The present invention has an advantage in that, by using a pressure sensitive adhesive (PSA) as a binder, room temperature conditions can be applied, thereby greatly reducing manufacturing costs and time.

In a preferred embodiment of the present invention, the pressure sensitive adhesive (PSA) may be a crosslinkable polymer that does not contain fluorine (Fluorine).

The pressure sensitive adhesive (PSA) may be a polymer that does not include fluorine (F-free) and includes an unsaturated C–C double bond. In the present invention, by using a pressure sensitive adhesive (PSA) that does not include fluorine, film formation of an electrode active material layer is possible under low-temperature conditions, environmental problems can be reduced, and side reactions such as irreversible decomposition of a binder under operating voltage conditions of a secondary battery can be suppressed.

In addition, the pressure sensitive adhesive(PSA) according to a preferred embodiment of the present invention can form a crosslinked structure by including an unsaturated C–C double bond, and, when film formation proceeds, can form a three-dimensional binder network between electrode active material particles.

In a preferred embodiment of the present invention, the pressure sensitive adhesive (PSA) may include one or more polymer compounds selected from the group consisting of: one or more styrene block copolymers selected from the group consisting of styrene-butadiene rubber (SBR), a styrene-butadiene-styrene block copolymer (SBS), and a styrene-isoprene-styrene block copolymer (SIS); polybutadiene (PB); a styrene-ethylene-butylene-styrene copolymer (SEBS); one or more polyolefins selected from the group consisting of polyethylene (PE), polypropylene (PP), and polybutylene; thermoplastic polyurethane (TPU); poly alcohol, poly imide, poly ester, polyvinyl chloride, a silane-based binder, ethylene oxide, an epoxy resin, a rubber-polyolefin blend; and a polyrotaxane-based polymer.

However, the present invention is not necessarily limited thereto, and other compounds may also be selected as long as they are crosslinkable, do not contain fluorine, and are polymer compounds that exhibit adhesiveness in response to pressure and have properties that do not deviate from the purpose of the present invention.

More preferably, the pressure sensitive adhesive (PSA) may be styrene-butadiene rubber.

Meanwhile, the step 2) may be performed under a temperature condition of 0°C to 40°C. Specifically, it may mean room temperature conditions, and more specifically, it may mean 10°C to 25°C. Therefore, according to a preferred embodiment of the present invention, separate cooling or heating equipment may not be required.

In addition, press molding of the step 2) may further include a calendaring process of pressurizing while passing the mixture of the step 1) between rolls. However, in the present invention, the press molding rolls used may not be heated rolls. That is, since the present invention is performed at room temperature, a sufficiently stable electrode is manufactured even when calendaring is performed using non-heated rolls.

In a preferred embodiment of the present invention, the step 2) may be to form by applying a pressure of 0.7 MPa or more. When the pressure for forming in the step 2) is less than 0.7 MPa, film formation does not proceed sufficiently, and thus formation of an electrode active material layer may be difficult. Preferably, the step 2) may be to form by applying a pressure of 0.7 MPa to 2.0 MPa. Even if the forming pressure in the step 2) exceeds 2.0 MPa, there is no substantial difference in physical properties of the secondary battery anode manufactured to a degree of film formation, and thus it is preferable to form within the above range of pressure.

In a preferred embodiment of the present invention, the secondary battery electrode is an anode, and the electrode active material may be one or more carbon-based materials selected from the group consisting of graphite, coke, carbon nanotubes, and graphene. Preferably, the carbon-based material may be in a powder-phase. In addition, preferably, the carbon-based material may be graphite.

The present invention is also manufactured by the above-described method for manufacturing a dry secondary battery electrode,

provides a secondary battery electrode including: an electrode active material; and, as a binder binding the electrode active material, a pressure sensitive adhesive (PSA).

Preferably, the pressure sensitive adhesive (PSA) may form a three-dimensional network between the electrode active material particles and may bind the electrode active material particles.

In a preferred embodiment of the present invention, the pressure sensitive adhesive (PSA) may be a polymer that does not include fluorine (F-free) and includes an unsaturated C–C double bond. Since this is the same as described in the method for manufacturing a dry secondary battery electrode, a detailed description thereof will be omitted.

In a preferred embodiment of the present invention, the electrode active material may be a powder-phase carbon-based material included in an amount of 90 wt% to 97 wt%. When the content of the powder-phase carbon-based material is less than 90 wt%, electrical conductivity of the anode is decreased, so that electrochemical characteristics of a secondary battery may be decreased, and when the content of the powder-phase carbon-based material exceeds 97 wt%, the content of a binder (pressure sensitive adhesive) is insufficient, so that film formation does not proceed sufficiently and a powder form may remain, and elasticity of the manufactured dry secondary battery electrode is insufficient, so that durability of the secondary battery may be deteriorated.

In a preferred embodiment of the present invention, the electrode active material is in a powder-phase, and the pressure sensitive adhesive (PSA) not including fluorine may fix the electrode active material in a bridge shape connecting between the electrode active material particles.

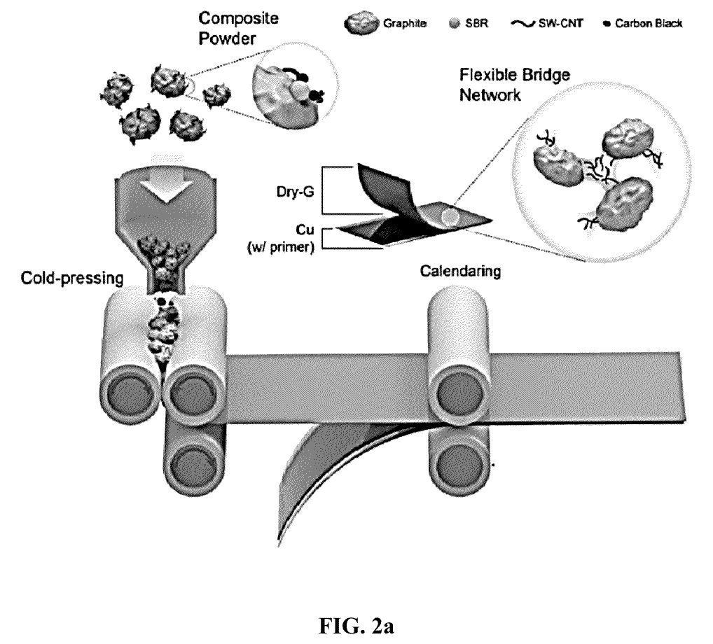

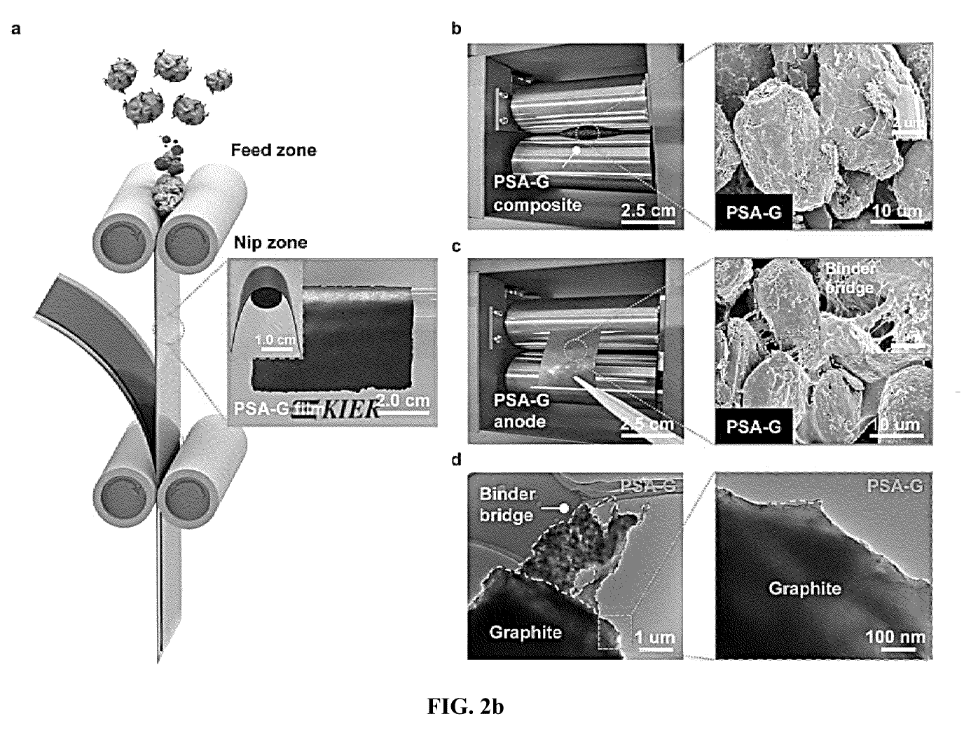

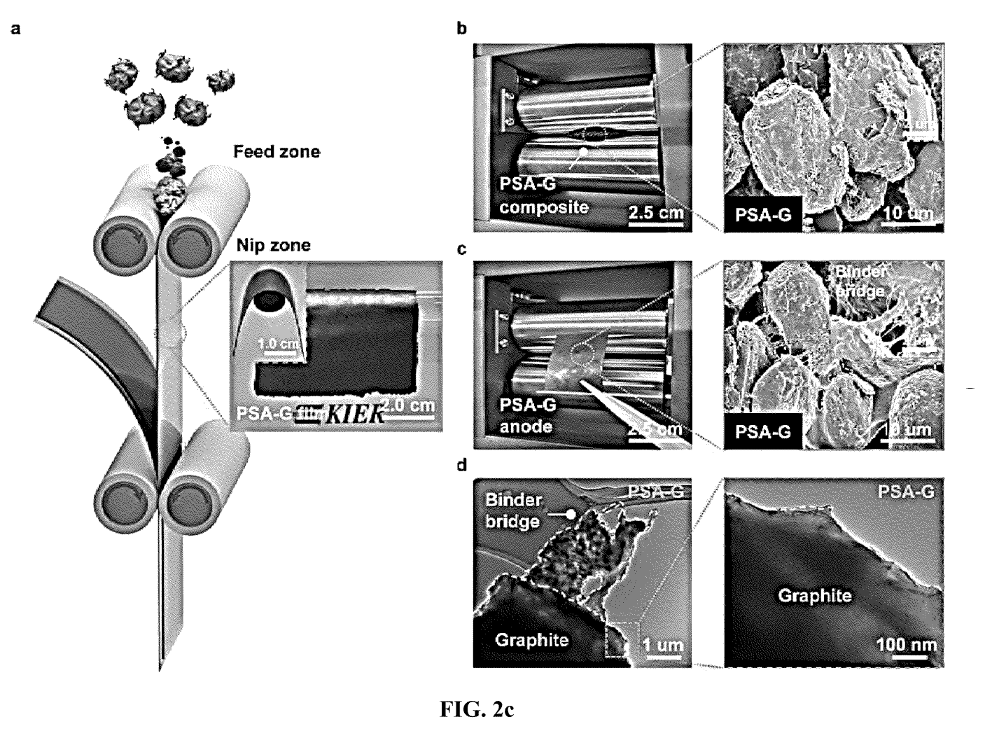

FIG. 2 is a schematic diagram schematically showing a method for manufacturing a dry graphite anode according to a preferred embodiment of the present invention. FIG. 2a is a schematic diagram showing an overall process, FIG. 2b is an electron microscope photograph capturing an appearance of a mixture obtained by mixing graphite powder and a pressure sensitive adhesive (PSA) before performing press molding (calendaring), and FIG. 2c is an electron microscope photograph capturing an appearance after press molding.

Referring to FIG. 2c, it can be confirmed that the pressure sensitive adhesive (PSA), which is a binder, crosslinks between graphite particles in a bridge form.

Unlike, in a wet process, a binder forms a binder layer on a surface of an electrode active material to block contact between the electrode active material and an electrolyte and form a closed-channel interface, in the secondary battery electrode according to the present invention, a pressure sensitive adhesive (PSA), as a binder, forms point-to-point bonding with electrode active material particles and forms a network between the electrode active material particles in a bridge form, thereby allowing the electrode active material particles to have a more open structure with respect to the electrolyte and to form an open-channel interface.

The present invention also provides a secondary battery including: the above-described secondary battery electrode; a counter electrode; a separator interposed between the secondary battery electrode and the counter electrode; and an electrolyte impregnated in the separator. Hereinafter, each configuration of the secondary battery including the secondary battery electrode will be described in detail. Descriptions overlapping with those described for the method for manufacturing a dry secondary battery electrode will be omitted.

### A cathode

A cathode according to the present invention may include a cathode current collector and a cathode active material layer disposed on at least one surface of the cathode current collector. The cathode active material layer may include a cathode active material, a conductive material, and a cathode binder.

The cathode current collector is not particularly limited as long as it has high conductivity without causing a chemical change in a battery. Specifically, as the cathode current collector, copper, stainless steel, aluminum, nickel, titanium, baked carbon, one obtained by surface-treating a surface of copper or stainless steel with carbon, nickel, titanium, silver, or the like, an aluminum-cadmium alloy, and the like may be used. The cathode current collector may generally have a thickness of 6 to 20 μm.

In a preferred embodiment of the present invention, the cathode active material may include a lithium transition metal oxide. The lithium transition metal oxide may be, for example, one or more selected from the group consisting of Liₓ₁CoO₂ (0.5<x1<1.3), Liₓ₂NiO₂ (0.5<x2<1.3), Liₓ₃MnO₂ (0.5<x3<1.3), Liₓ₄Mn₂O₄ (0.5<x4<1.3), Liₓ₅(Niₐ₁Co_{b1}Mn_{c1})O₂ (0.5<x5<1.3, 0<a1<1, 0<b1<1, 0<c1<1, a1+b1+c1=1), Li ₓ₆Ni_{1-y1}Co_{y1}O₂ (0.5<x6<1.3, 0<y1<1), Liₓ₇Co_{1-y2}Mn_{y2}O₂ (0.5<x7<1.3, 0≤y2<1), Liₓ₈Ni_{1-y3}Mn_{y3}O₂ (0.5<x8<1.3, O≤y3<1), Liₓ₉(Niₐ₂Co_{b2}Mn_{c2})O₄ (0.5<x9<1.3, 0<a2<2, 0<b2<2, 0<c2<2, a2+b2+c2=2), Liₓ₁₀Mn_{2-z1}Ni_{z1}O₄ (0.5<x10<1.3, 0<z1<2), Liₓ₁₁Mn_{2-z}2Co_{z2}O₄ (0.5<x11<1.3, 0<z2<2), Liₓ₁₂CoPO₄ (0.5<x12<1.3), and Liₓ₁₃FePO₄ (0.5<x13<1.3).

The conductive material used in the cathode can improve conductivity between active material particles or with a metal current collector and can prevent a binder from acting as an insulator. The conductive material may be, for example, a mixture of one or two or more conductive materials selected from the group consisting of graphite, carbon black, carbon fibers, metal fibers, metal powder, conductive whiskers, conductive metal oxides, activated carbon, and polyphenylene derivatives, and, more specifically, may be a mixture of one or two or more conductive materials selected from the group consisting of natural graphite, artificial graphite, Super-p, acetylene black, ketjen black, channel black, furnace black, lamp black, thermal black, Denka black, aluminum powder, nickel powder, zinc oxide, potassium titanate, and titanium oxide.

The cathode active material layer may preferably be manufactured by the above-described method for manufacturing a dry secondary battery electrode, and, in this case, the cathode binder may be the above-described pressure sensitive adhesive (PSA). In addition, the cathode active material layer may also be manufactured by a conventional wet process, and, in this case, the cathode binder may be, for example, one or more selected from poly(vinylidene fluoride), poly(vinylidene fluoride co-hexafluoropropylene), poly(vinylidene fluoride-co-trichloroethylene), poly(methylmethacrylate), poly(ethylhexylacrylate), poly(butylacrylate), poly(acrylonitrile), poly(vinylpyrrolidone), poly(vinyl acetate), poly(ethylene-co-vinyl acetate), poly(ethylene oxide), polyacrylate, cellulose acetate, cellulose acetate butyrate, cellulose acetate propionate, cyano ethyl pullulan, cyano ethyl poly(vinylalcohol), cyanoethylcellulose, cyano ethylsucrose, pullulan, and carboxyl methyl cellulose (Carboxyl methyl cellulose), but is not limited thereto.

### An anode

An anode according to the present invention includes an anode current collector and an anode active material layer formed on at least one surface of the anode current collector.

The anode current collector according to the present invention can serve as a passage for delivering electrons from the outside to an anode active material or receiving electrons from the anode active material and sending the electrons to the outside so that an electrochemical reaction can occur when a secondary battery is charged or discharged.

The anode current collector according to the present invention may include one or more of copper foil (Cu foil), stainless steel, nickel, and aluminum foil, or an alloy of two or more thereof, and may specifically include copper foil. According to one embodiment of the present invention, electrochemical characteristics may be further improved by using copper foil or aluminum foil as an anode current collector.

A thickness of the anode current collector according to the present invention is not particularly limited, but may be, for example, 3 to 100 μm, 10 to 25 μm, or 10 to 15 μm.

The anode active material layer may further include a conductive material in addition to the electrode active material and a binder (pressure sensitive adhesive). The conductive material can improve conductivity between anode active material particles or between the anode active material particles and the anode current collector and can prevent the binder from acting as an insulator. The conductive material may be, for example, a mixture of one or two or more conductive materials selected from the group consisting of graphite, carbon black, carbon fiber, metal fiber, metal powder, conductive whisker, conductive metal oxide, activated carbon, and polyphenylene derivatives, and, more specifically, may be a mixture of one or two or more conductive materials selected from the group consisting of natural graphite, artificial graphite, Super-p, acetylene black, ketjen black, channel black, furnace black, lamp black, thermal black, denka black, aluminum powder, nickel powder, zinc oxide, potassium titanate (K ₂TiO₃), and titanium oxide (TiO₂).

The conductive material may be included in an amount of 1 wt% to 3 wt% based on a total weight of the anode active material layer.

### Separator

A separator according to the present invention may include a porous substrate.

The porous substrate according to the present invention may be a porous structure having high resistance to an electrolyte solution and having a fine pore diameter, which can electrically insulate the anode and the cathode to prevent a short circuit while providing a movement path of lithium ions.

As a constituent material of the porous substrate, an organic material or an inorganic material having electrical insulation may be used without particular limitation. The porous substrate may include at least one selected from the group consisting of polyolefin, polyethylene terephthalate, polybutylene terephthalate, polyacetal, polyamide, polycarbonate, polyimide, polyether ether ketone, polyethersulfone, polyphenylene oxide, polyphenylene sulfide, and polyethylene naphthalene, and may specifically include polyolefin. Polyolefin not only has excellent coatability but also can increase capacity per volume by reducing a thickness of a separator to increase a ratio of an electrode active material layer in a battery. Specifically, a weight average molecular weight (Mw) of the polyolefin may be 100,000 to 500,000 g/mol. When the weight average molecular weight of the polyolefin is less than the above numerical range, it may become difficult to secure sufficient mechanical properties, and when the weight average molecular weight exceeds the above numerical range, a shutdown function may not be implemented or molding may become difficult. The shutdown function refers to a function of, when a temperature of a secondary battery increases, a thermoplastic resin melts to close pores of a porous substrate, thereby blocking movement of ions and preventing thermal runaway of the battery.

A thickness of the porous substrate may be, for example, 3 to 50 μm or 4 to 15 μm. When the thickness of the porous substrate is less than the numerical range, a function of a conductive barrier may not be sufficient, and when the thickness exceeds the numerical range, resistance of a separator may be excessively increased.

An average diameter of pores included in the porous substrate may be, for example, 10 to 100 nm. The pores included in the porous substrate have a structure connected to each other, so that gas or liquid can pass from one surface of the porous substrate to another surface.

According to another embodiment of the present invention, the porous substrate may include a polyethylene substrate and polypropylene coating layers formed on both surfaces of the polyethylene substrate.

### Electrolyte

An electrolyte according to the present invention may include a solvent and a lithium salt.

A solvent according to the present invention may be, for example, one or a mixture of two or more selected from the group consisting of propylene carbonate (PC), ethylene carbonate (EC), diethyl carbonate (DEC), dimethyl carbonate (DMC), dioxolane (DOL), dimethoxyethane (DME), dipropyl carbonate (DPC), dimethyl sulfoxide, acetonitrile ), dimethoxyethane, diethoxyethane, tetrahydrofuran, N-methyl-2-pyrrolidone (NMP), ethylmethyl carbonate (EMC), γ-butyrolactone (GBL), fluoroethylene carbonate (FEC), methyl formate, ethyl formate, propyl formate, methyl acetate, ethyl acetate, propyl acetate, pentyl acetate, methyl propionate, ethyl propionate, propyl propionate, and butyl propionate.

A lithium salt according to the invention may include, for example, an anion such as NO₃⁻, F⁻, Cl⁻, Br⁻, I⁻, PF₆⁻, and the like, and may specifically include a fluoride ion (F⁻). Here, the lithium salt including a fluoride ion may include LiTFSI (Lithium bis-trifluoromethanesulfonimide) or LiPF₆, and the like.

According to another embodiment of the present invention, as a fluoride ion is included in the electrolyte solution, a solid electrolyte interface (SEI) including LiF may be formed between an anode current collector and the electrolyte solution. By forming an SEI (LiF-rich layer) including a large amount of lithium fluoride (LiF), interfacial stabilization in a lithium metal battery may be induced, so that excellent cycle characteristics may be implemented.

Hereinafter, effects of the present invention will be specifically described by taking specific examples and experimental results. The following examples are merely examples given so that embodiments of the present invention can be specifically understood, and do not limit the scope of the present invention. A person reading the present specification should understand that a person skilled in the art can implement the present invention by adding other configurations, deleting non-essential configurations, or substituting the same, except for essential configurations of the present invention, and this is easy from the description of the present specification, and such embodiments are also within the scope of the present invention.

### <Examples>

### <Examples 1>

Natural graphite (918-Ⅱ, BTR New Material Group) as an anode active material, single wall-carbon nanotubes (SWCNT; Tuball, OCSiAl, Luxembourg) and Super-P (Imerys, France) as conductive materials, and styrene-butadiene rubber (BM400B, Zeon, Japan), which is a pressure sensitive adhesive (PSA), as a binder were each weighed at a mass ratio of 95:0.1:0.9:4, and then uniformly mixed with a mixer, and cooled for 6 hours in a freezer at about −21°C. Thereafter, an anode mixture was obtained through freeze-drying and pulverization processes.

After the anode mixture was uniformly applied, at a loading amount of about 15 mg/cm², onto a copper foil coated with a conductive polymer primer, a graphite anode was manufactured by pressurizing at a pressure of 1 MPa at room temperature using a uniaxial press apparatus.

### <Examples 2>

The procedure was performed in the same manner as in Example 1, except that a loading amount of the anode mixture was increased to 29 mg/cm².

### <Examples 3>

The procedure was performed in the same manner as in Example 1, except that the anode mixture was press molded at room temperature at a pressure of about 0.65 MPa.

### <Examples 4>

The procedure was performed in the same manner as in Example 1, except that the anode mixture was press molded at room temperature by hand pressure.

### <Comparative Example 1>

Natural graphite (same as in Example 1) as an anode active material, single wall carbon nanotubes (same as in Example 1) and Super-P (same as in Example 1) as conductive materials, SBR as a binder, and a CMC-Na salt (Sodium carboxymethyl cellulose, Nippon Paper Industries, Japan) as a thickener were uniformly mixed at a mass ratio of 95:0.1:0.9:2:2, dissolved in distilled water, and a slurry was prepared using a Thinky mixer. After the slurry was coated on a copper foil using a doctor blade, the slurry was dried at 80°C for about 1 hour, and then additionally dried overnight in a vacuum oven. Thereafter, a wet anode was completed using a roll press.

### <Comparative Example 2>

Natural graphite (same as in Example 1) as an anode active material, Super-P (same as in Example 1) as a conductive material, and polytetrafluoroethylene (PTFE; F104, Daikin Industries, Japan) as a binder were mixed at a mass ratio of 95:1:4, and then uniformly mixed while applying shear force using a mortar to prepare an anode mixture. After flattening for about 15 minutes while applying pressure to the anode mixture, the anode mixture was attached to a copper foil coated with a primer to manufacture a dry anode. The loading amount of the anode mixture was set to 20 mg/cm².

### <Preparation Example 1>

A half-cell was manufactured using the anode of Example 1 as a working electrode and lithium metal as a reference electrode. As an electrolyte, a solution in which LiPF₆ was dissolved at a concentration of 1 M in an ethylene carbonate and dimethyl carbonate (EC/DMC) solvent mixed at a volume ratio of 1:1 was used, and as a separator, a polyethylene (W-SCOPE) separator was used.

### <Preparation Example 2>

A half-cell was manufactured in the same manner as in Preparation Example 1, except that the anode of Example 2 was used as a working electrode.

### <Preparation Example 3>

Lithium iron phosphate (M23, Aleees) as a cathode active material, single wall carbon nanotubes (Tuball, OCSiAl, Luxembourg) and Super-P (Super-P, Imerys, France) as conductive materials, and styrene-butadiene rubber (BM400B, Zeon, Japan), which is a pressure sensitive adhesive (PSA), as a binder were weighed and mixed in the same manner as the anode mixture, and a cathode mixture was obtained through freeze-drying and pulverization processes.

After the cathode mixture was uniformly applied, at a loading amount of 36 mg/cm², onto an aluminum foil coated with a primer, a cathode was manufactured by applying the same dry process as the anode of Example 1.

A 2032-type full cell was manufactured by interposing a polyethylene (W-SCOPE) separator between the cathode and the anode, and impregnating an electrolyte in which LiPF₆ was dissolved at a concentration of 1 M in an ethylene carbonate and dimethyl carbonate (EC/DMC) solvent mixed at a volume ratio of 1:1.

### <Comparative Preparation Example 1>

A half-cell was manufactured in the same manner as in Preparation Example 1, except that the anode of Comparative Example 1 was used as a working electrode.

### <Comparative Preparation Example 2>

A half-cell was manufactured in the same manner as in Preparation Example 1, except that the anode of Comparative Example 2 was used as a working electrode.

### <Comparative Preparation Example 3>

A full cell was manufactured in the same manner as in Preparation Example 3, except that the anode was replaced with the anode according to Comparative Example 1.

### <Comparative Preparation Example 4>

A full cell was manufactured in the same manner as in Preparation Example 3, except that the anode was replaced with the anode according to Comparative Example 2.

### <Experimental Examples>

### Experimental Example 1: Appearance Observation of Dry Graphite Anode

### (1) Visual observation

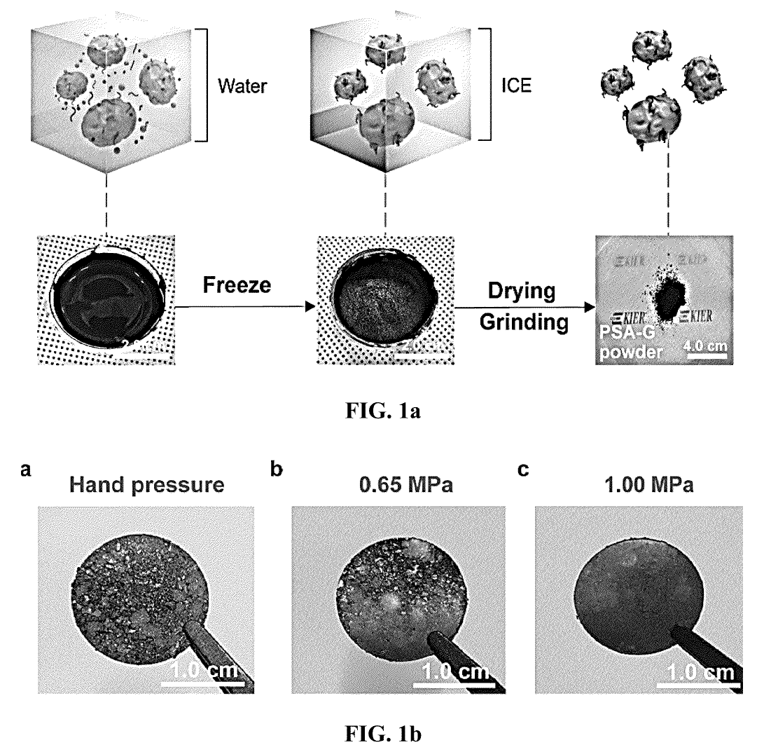

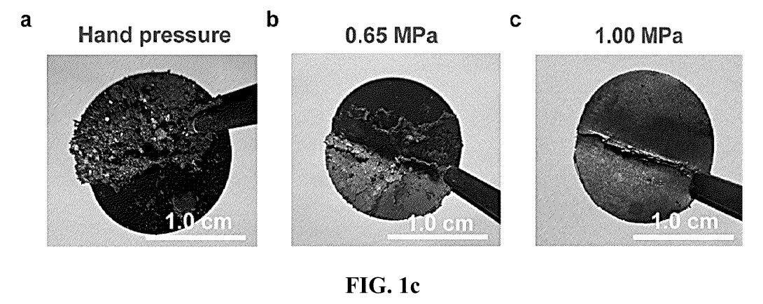

Dry graphite anodes manufactured according to Examples 1, 3, and 4 were visually observed, and results thereof are shown in FIG. 1b. Graphite anodes of Examples 4, 3, and 1 are shown in order from left to right.

Referring to FIG. 1b, it can be confirmed that, in the anode of Example 4 to which pressure was applied by hand and the anode of Example 3 in which pressure of a press is 0.65 MPa, the powder-phase anode mixture did not sufficiently form into a film and a powder form remained. On the other hand, in the case of Example 1 in which the press pressure exceeds 0.7 MPa (1.00 MPa), it can be confirmed that a powder form disappeared and film formation was almost perfectly achieved.

FIG. 1c is a photograph comparing breaking shapes when folding was performed for each graphite anode of FIG. 1b. Graphite anodes of Examples 4, 3, and 1 are shown in order from left to right in FIG. 1c. In Example 4, a fragile appearance crumbling in a powder form can be seen, and Example 3 shows an appearance that is partially delaminated in layers but crumbles. In Example 1, it can be confirmed that the entire layer is formed into a film and is delaminated in layers without crumbling.

### (2) High-resolution scanning electron microscope (HR-SEM) observation

A microstructure of a graphite anode manufactured according to Example 1 was observed through a scanning electron microscope, and results thereof are shown in FIG. 2. As a control group, a microstructure of an anode mixture before performing a calendaring process was observed through a scanning electron microscope.

FIG. 2b shows a microstructure of an anode mixture before performing a calendaring process, and FIG. 2c shows a microstructure of a graphite anode formed into a film through a calendaring process.

Referring to FIG. 2b, it is clearly separated between graphite particles before calendaring, but it can be confirmed that, in a graphite anode formed into a film through a calendaring process according to Example 1, SBR forms a network while forming a bridge structure between graphite particles to bind the graphite particles.

### (3) Transmission electron microscope (TEM) observation

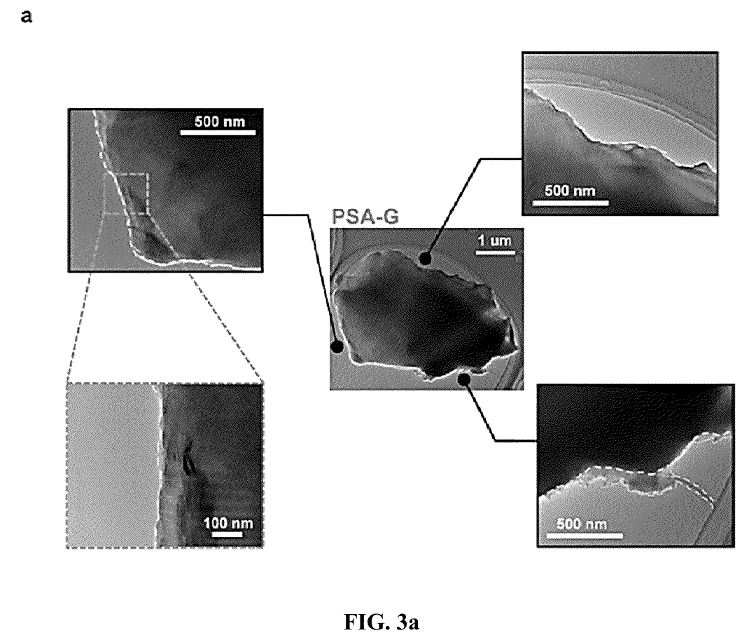

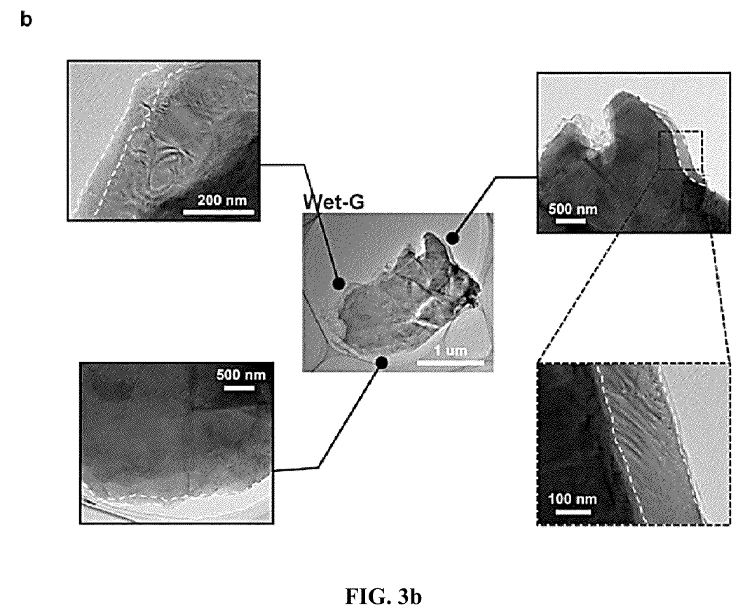

Surfaces of graphite particles included in graphite anodes manufactured according to Example 1 and Comparative Example 1 were observed with a transmission electron microscope, and results thereof are shown in FIGS. 3a and 3b.

Referring to FIG. 3a, it can be confirmed that, in the graphite anode manufactured according to a preferred embodiment of the present invention, a binder layer is not formed on a surface of graphite particles or only a portion of an area is in contact with the binder (lower right). Accordingly, it was confirmed that, when a graphite anode is manufactured by a dry process according to the present invention, an open-channel interface is achieved in which contact between an electrode active material and an electrolyte is not limited by a binder.

On the other hand, referring to FIG. 3b, it can be seen that, in a graphite anode manufactured by a wet process, most of a surface of graphite particles is covered with a layer of a binder, thereby forming a closed-channel interface.

### Experimental Example 2: Evaluation of Electrochemical Characteristics of Half-Cell

### (1) Comparison of electrochemical characteristics according to active material loading amount

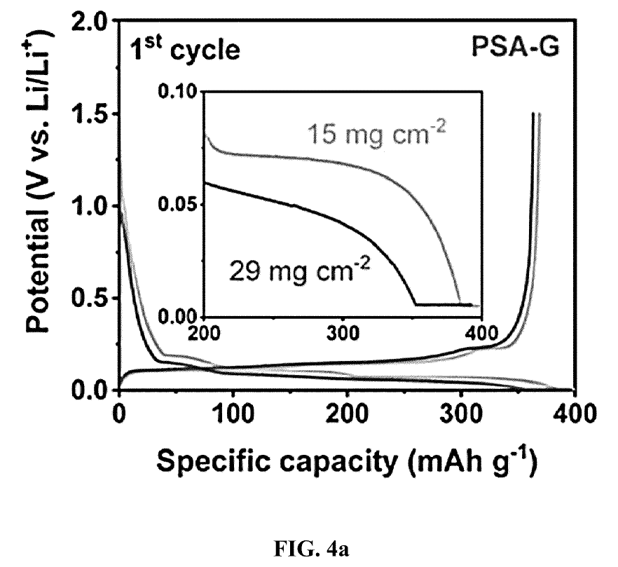

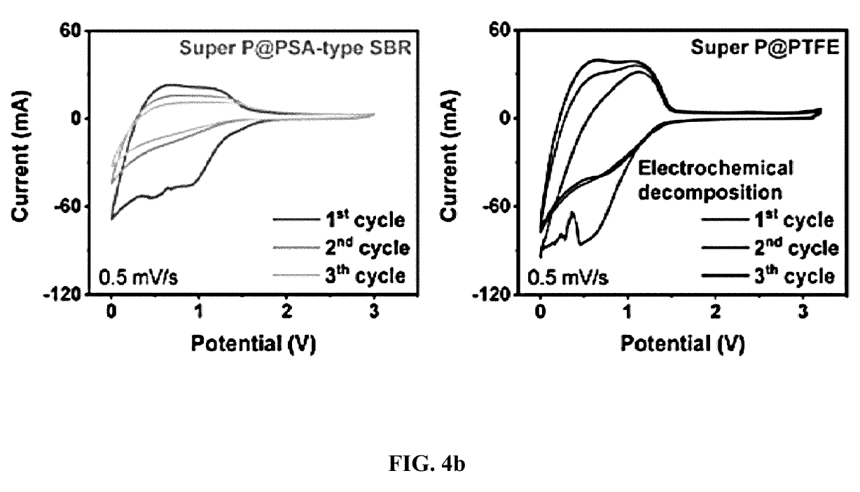

While applying a current of 0.05 C to half-cells according to Preparation Examples 1 and 2, charge and discharge were performed under CC-CV (Constant Current-Constant Voltage) conditions, and voltage profiles for an initial cycle are shown in FIG. 4a.

Referring to FIG. 4a, it can be seen that a capacity of Preparation Example 1 in which an anode active material loading amount is 15 mg/cm² is about 368.4 mAh/g, and a capacity of Preparation Example 2 in which an anode active material loading amount is 29 mg/cm² is about 363.4 mAh/g, and, in both cases, values close to 372 mAh/g, which is a theoretical capacity of graphite, are exhibited. Accordingly, it was found that the method for manufacturing a secondary battery electrode according to the present invention has almost no decrease in specific capacity according to a change in active material loading amount, even though it is manufactured by a dry process.

### (2) Comparison with a dry graphite anode using a fluorine-based binder

Cyclic voltammetry (CV) was performed on the half-cells of Preparation Example 1 and Comparative Preparation Example 2 at a scan rate of 0.2 mV/s, and results thereof are shown in FIG. 4b.

Referring to FIG. 4b, in Preparation Example 1 (Super P@PSA-G), in a first cycle, a current signal slightly changes in a voltage range of 0 to 1 V, but it can be seen that stable electrochemical behavior is exhibited in second and third cycles thereafter. This means that the graphite anode of Example 1 exhibits stable electrochemical characteristics from an initial cycle. On the other hand, in Comparative Preparation Example 2 (Super P@PTFE), a rapid reductive decomposition current signal is observed at 1 V or lower in the first cycle. This means that PTFE was electrochemically decomposed.

### Experimental Example 3: Evaluation of Electrochemical Characteristics of Full Cell

### (1) Rate characteristic evaluation

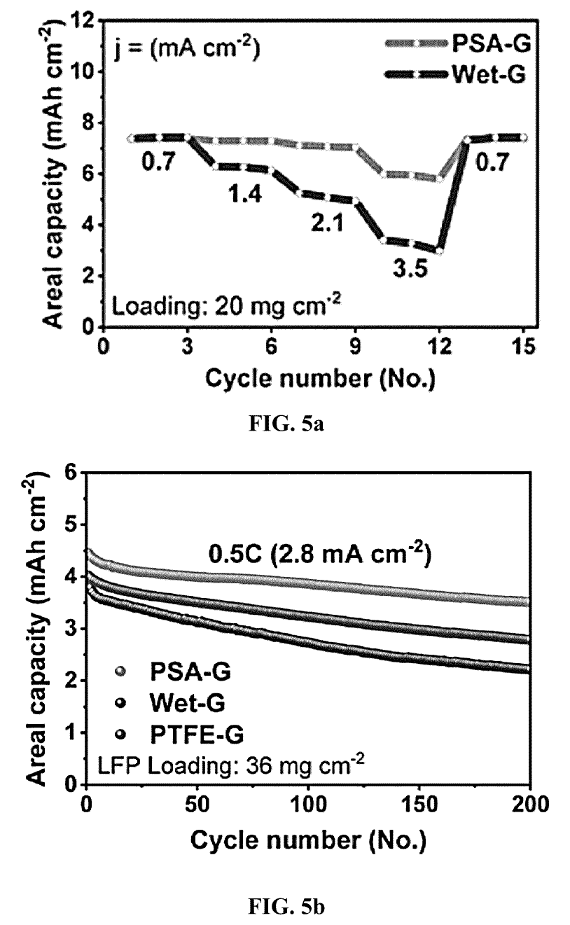

Charge-discharge characteristics were examined by repeating charge-discharge cycles while varying current density (indicated below the graph) for full cells of Preparation Example 3 and Comparative Preparation Example 3. Results thereof are shown in FIG. 5a.

Referring to FIG. 5a, it could be confirmed that a capacity of a cell of Preparation Example 3 is high at most current densities. In particular, it can be seen that, as current density increases, capacity decrease of an electrode manufactured by a wet process becomes severe. This is determined to be because, when manufactured by a wet process, a layer of a binder is formed on a surface of an active material to form a closed-channel interface, thereby reducing accessibility between an electrolyte and the active material.

### (2) Cycle characteristic evaluation

For full cells of Preparation Example 3, Comparative Preparation Example 3, and Comparative Preparation Example 4, charge and discharge were performed for 200 cycles while applying a current density of 0.5 C, and results thereof are shown in FIG. 5b. PSA-G represents Preparation Example 3, Wet-G represents Comparative Preparation Example 3, and PTFE-G represents Comparative Preparation Example 4.

Referring to FIG. 5b, it can be confirmed that a full cell including an anode manufactured by the method according to a preferred embodiment of the present invention exhibits a high capacity, and a capacity retention rate thereof is also excellent. In Comparative Preparation Example 3 including an anode manufactured by a wet process, it was confirmed that not only a capacity is low compared to Preparation Example 3 but also a capacity retention rate is low. In addition, Comparative Preparation Example 4 includes an anode manufactured by a dry process using a PTFE binder, and has a higher capacity and a higher capacity retention rate than an anode manufactured by a wet process, but it can be seen that Comparative Preparation Example 4 has a lower capacity and a lower capacity retention rate than Preparation Example 3. This is determined to be because PTFE, which is a fluorine-based binder, is irreversibly decomposed as cycles are repeated, thereby deteriorating durability of an anode.

1. A method for manufacturing a secondary battery electrode, comprising:
1) mixing an electrode active material and a pressure sensitive adhesive (PSA); and
2) pressurizing the mixture of the step 1) to form the mixture into a film shape.

1) mixing an electrode active material and a pressure sensitive adhesive (PSA); and

2. The method for manufacturing a secondary battery electrode according to claim 1,
wherein the pressure sensitive adhesive (PSA) does not include fluorine.

3. The method for manufacturing a secondary battery electrode according to claim 2,
wherein the pressure sensitive adhesive (PSA) is a polymer including an unsaturated C–C double bond.

4. The method for manufacturing a secondary battery electrode according to claim 1,
wherein the step 1) further includes, thereafter, performing a freeze-drying process on the mixture.

5. The method for manufacturing a secondary battery electrode according to claim 4,
wherein the freeze-drying process includes a step of freezing at a rate of 0.5°C/sec to 1°C/sec.

6. The method for manufacturing a secondary battery electrode according to claim 1,
wherein the step 2) is performed at a temperature of 0°C to 40°C.

7. The method for manufacturing a secondary battery electrode according to claim 1,
wherein the step 2) is performed by applying a pressure of 0.7 MPa or more.

8. The method for manufacturing a secondary battery electrode according to claim 1,
wherein the secondary battery electrode is an anode, and
wherein the electrode active material is a carbon-based active material.

9. A secondary battery electrode manufactured by the method for manufacturing a secondary battery electrode according to claim 1.

10. The secondary battery electrode according to claim 9, wherein the pressure sensitive adhesive (PSA) does not include fluorine and is a polymer including an unsaturated C–C double bond.

11. A secondary battery comprising: a secondary battery electrode according to claim 9; a counter electrode; a separator interposed between the secondary battery electrode and the counter electrode; and an electrolyte impregnated in the separator.
